(19) United States
(12) Patent Application Publication
(10) Pub. No.: US 2024/0354182 A1
(43) Pub. Date: Oct. 24, 2024

(54) CAUSALITY SEARCH APPARATUS, CAUSALITY SEARCH METHOD, AND COMPUTER-READABLE RECORDING MEDIUM

(71) Applicant: NEC Corporation, Minato-ku, Tokyo (JP)

(72) Inventors: Shohei MITANI, Tokyo (JP); Hirofumi UEDA, Tokyo (JP)

(73) Assignee: NEC Corporation, Minato-ku, Tokyo (JP)

(21) Appl. No.: 18/685,320

(22) PCT Filed: Sep. 6, 2021
(86) PCT No.: PCT/JP2021/032718

§ 371 Date: Feb. 21, 2024

(51) Int. Cl. G06F 11/07

(52) U.S. Cl. CPC G06F 11/0751; G06F 11/0793

(57) ABSTRACT

A causality search apparatus including: a causality information calculation unit that selects two different components from a plurality of components provided in a target system and calculating causality information indicating causality between the two selected components; and a causality information correction unit that corrects the causality information based on function information indicating functions respectively associated with the two selected components.

### TECHNICAL FIELD

The technical field relates to a causality search apparatus and a causality search method for searching for a causality, and further relates to a computer-readable recording medium on which a program for realizing the causality search apparatus and the causality search method is recorded.

### BACKGROUND ART

In, for example, an operational technology (OT) or Internet of things (IoT) system, when an abnormality is detected in the system, there is a need to estimate a cause of the abnormality and to establish a countermeasure for restoring the system to a desired state. However, an accurate causality is required in order to estimate the cause of the abnormality and establish a countermeasure.

As a related technique, Patent Document 1 discloses a causality learning apparatus that estimates a causality without the need for presetting a regression model. The causality learning apparatus disclosed in Patent Document 1 first calculates a feature amount of time-series data using a correct label of classification labels classified into three or more labels related to the causality of time-series data and time-series data corresponding to the correct label. Next, a classifier is taught so that the output of the classifier with respect to the feature amount reaches the maximum value of the output value of the correct label, using the calculated feature amount and the correct label pair.

### LIST OF RELATED ART DOCUMENTS

### Patent Document

Patent Document 1: Japanese Patent Laid-Open Publication No. 2019-185194

### SUMMARY

### Technical Problems

A system such as an OT or IoT system is a physical system. Therefore, there may be a false correlation in which data output from one component and data output from the other component appear to be synchronized with each other even though there is no correlation between the data output from the two components. When the regression model disclosed in Patent Document 1 or the like is used when there is a false correlation, regression is established even though there is no causality between the components.

However, it is difficult to eliminate a false correlation, and thus it is difficult to accurately estimate the causality even when the regression model disclosed in Patent Document 1 or the like is used.

As one aspect, an object is to provide a causality search apparatus, a causality search method, and a computer-readable recording medium for accurately estimating a causality.

### Solution to the Problems

In order to achieve the example object described above, a causality search apparatus according to an example aspect includes:

a causality information calculation unit selects two different components from a plurality of components provided in a target system and calculates causality information indicating causality between the two selected components; and

a causality information correction unit that corrects the causality information based on function information indicating functions respectively associated with the two selected components.

Also, in order to achieve the example object described above, a causality search method according to an example aspect includes:

a causality information calculation step of selecting two different components from a plurality of components provided in a target system and calculating causality information indicating causality between the two selected components; and

a causality information correction step of correcting the causality information based on function information indicating functions respectively associated with the two selected components.

Furthermore, in order to achieve the example object described above, a computer-readable recording medium according to an example aspect includes a program recorded on the computer-readable recording medium, the program including instructions that cause the computer to carry out:

a causality information calculation step of selecting two different components from a plurality of components provided in a target system and calculating causality information indicating causality between the two selected components; and

a causality information correction step of correcting the causality information based on function information indicating functions respectively associated with the two selected components.

### Advantageous Effects of the Invention

As one aspect, the causality can be accurately estimated.

### BRIEF DESCRIPTION OF THE DRAWINGS

FIG. 1 is a diagram for explaining an example of a causality search apparatus.

FIG. 2 is a diagram for explaining an example of a data structure of component information.

FIG. 3 is a diagram for explaining an example of causality information.

FIG. 4 is a diagram for explaining an example of correction determination information.

FIG. 5 is a diagram for explaining an example of a system including a causality search apparatus.

FIG. 6 is a diagram for explaining an example of the operation of the causality search apparatus.

FIG. 7 is a diagram for explaining an example of the causality search apparatus according to the first modified example embodiment.

FIG. 8 is a diagram for explaining an example of a causality search apparatus according to the second modified example embodiment.

FIG. 9 is a diagram for explaining an example of a computer that realizes a causality search apparatus according to the example embodiment, the first modified example embodiment and the second modified example embodiment.

### EXAMPLE EMBODIMENT

Hereinafter, example embodiments will be described with reference to the drawings. In the drawings described below, elements having the same or corresponding functions are denoted by the same reference numerals, and repeated description thereof may be omitted.

### Example Embodiments

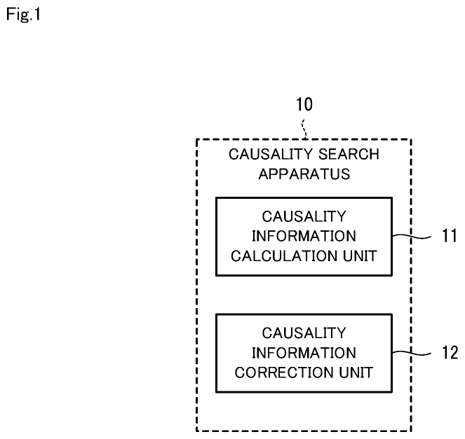

A configuration of a causality search apparatus according to a first example embodiment will be described with reference to FIG. 1. FIG. 1 is a diagram for explaining an example of a causality search apparatus.

### [Apparatus Configuration]

A causality search apparatus 10 is an apparatus that accurately estimates a causality between two components provided in a target system, based on the functions of the two components.

The target system is a system using an OT/IoT network or the like. The target system is, for example, a system used in a power plant, traffic equipment, a factory, an airplane, an automobile, a home appliance, or the like. The target system includes a plurality of components.

For example, a component provided in a target system is a setting device such as a switch or a relay, a driving device such as an actuator, a pump, or a robot arm, or a measurement device that outputs a signal or information such as pressure, a flow rate, a temperature, a voltage, or a current, which has been measured by the measurement apparatus.

The causality search apparatus 10 is, for example, a programmable device such as a central processing unit (CPU) or a field-programmable gate array (FPGA), a graphics processing unit (GPU), or a circuit on which any one or more of these are mounted, or an information processing device such as a server computer, a personal computer, or a mobile terminal.

As shown in FIG. 1, the causality search apparatus 10 includes a causality information calculation unit 11 and a causality information correction unit 12.

The causality information calculation unit 11 selects two different components (a pair) from a plurality of components provided in the target system, and calculates causality information indicating a causality between the two selected components (the pair).

The causality information correction unit 12 corrects the causality information based on function information indicating functions respectively associated with the two selected components.

As described above, in the example embodiment, the causality can be accurately estimated by correcting the causality information indicating the causality between two components, based on the functions respectively associated with the components.

For example, because a system such as IoT/OT is a physical system and has a large amount of sensor data that moves substantially in synchronization with a delay, it is difficult to eliminate a false correlation. However, because a false correlation can be eliminated to some extent using the example embodiment, it is possible to accurately estimate the causality.

The causality information calculation unit 11 will be specifically described.

First, the causality information calculation unit 11 selects two components in a permutation from among a plurality of components, based on component information stored in a storage device (not shown).

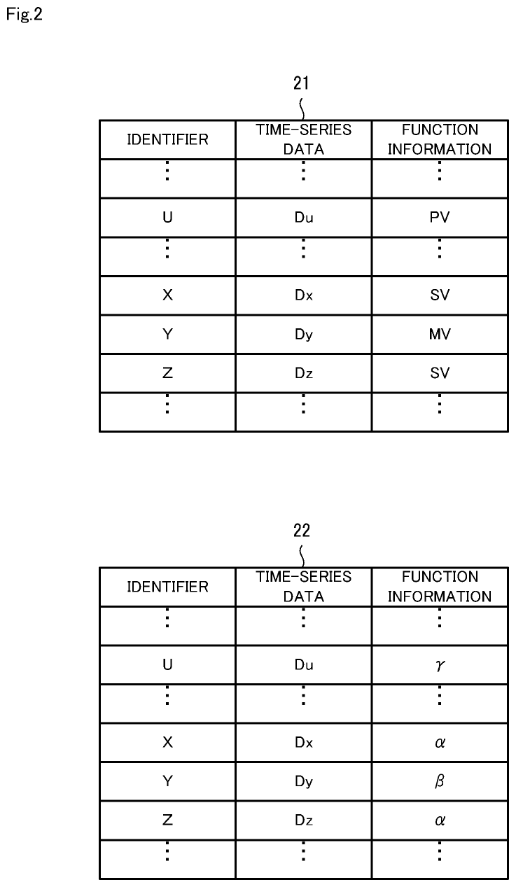

FIG. 2 is a diagram for explaining an example of a data structure of component information. In each of the pieces of component information 21 and 22, an identifier for identifying a component, time-series data obtained from the component, and function information indicating a function of the component are associated with each other.

The time-series data is data obtained from the component in time series. In the example of the component information 21 and 22 shown in FIG. 2, the time-series data Du is associated with the component U, the time-series data Dx is associated with the component X, the time-series data Dy is associated with the component Y, and the time-series data Dz is associated with the component Z.

The function information is, for example, information indicating a function of a setting device, a driving device, a measurement device, or the like. However, the function information may not be associated with an identifier.

When the function of the component is known in advance, information (label) indicating a following function may be associated with each component as in the component information 21 shown in FIG. 2. For example, the label of the setting device may be set variable (SV), which is a target value, the label of the driving device may be manipulative variable (MV), which is an output, and the label of the measurement device may be process variable (PV), which is a measurement value.

In addition to the above-stated label, label may also be information indicating a server, a client PC, a network device, an IoT device, a class of a command system, or the like.

If the function of a component is unclear, the same label may also be associated with components having a similar function as in the component information 22 shown in FIG. 2. In the component information 22, because the functions of the components X and Z are similar to each other, a label a indicating the same function is set as the function information.

The selection of two components will now be described. In the component information 21 or the component information 22 in FIG. 2, when three components related to the identifiers X, Y, and Z stored in the component information are targeted, the causality information calculation unit 11 selects six combinations of two components (X→Y), (Y→X), (X→Z), (Z→X), (Y→Z), (Z→Y) as permutations. That is, the causality information calculation unit 11 selects pairs of components with a direction.

Next, for each of the pairs, the causality information calculation unit 11 inputs the time-series data of the two components to a causality model for generating causality information indicating a causality between the components, and calculates the causality information.

The causality information is information indicating a causality between the time-series data obtained from the two components included in each pair. As the causality information, for example, the following cases (1) and (2) are conceivable.

The causality information in the case (1) is binary information indicating whether or not there is a causality between the time-series data obtained from the two components. In the binary information, for example, “1” is set when there is causality, and “0” is set when there is no causality.

The causality information in the case (2) is an index indicating the degree of causality between the time-series data obtained from the two components. The index is, for example, a score with a direction (causality score) or the like.

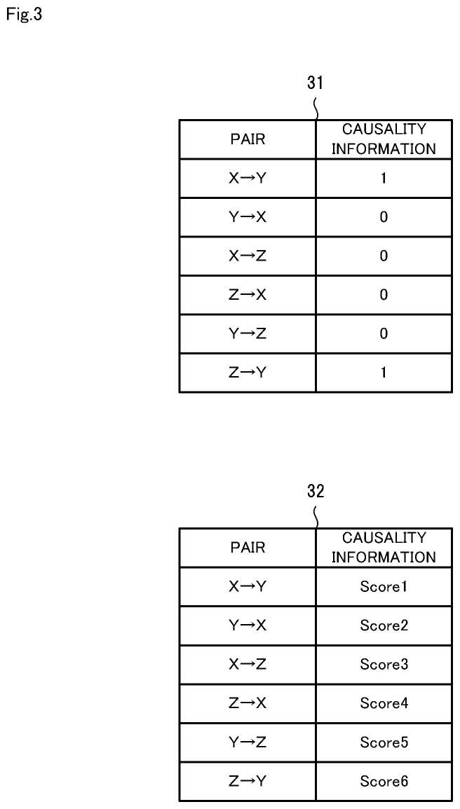

FIG. 3 is a diagram for explaining an example of causality information. When three components related to the identifiers X, Y, and Z stored in the component information are targeted, as in the example shown in FIG. 2, the causality information of the case (1) is stored in the storage device in association with information (one binary value) indicating whether or not there is a causality for each of the six combinations as shown in a table 31 in FIG. 3.

In contrast, as shown in a table 32 in FIG. 3, the causality information of the case (2) is stored in the storage device by associating a directional causality score (Score1 to Score6) as the causality information with each of the six combinations.

As the causality model, for example, a score-based method such as Granger causality, transfer Entropy, likelihood, Akaike information criterion (AIC), or Bayesian information criterion (BIC), a structural equation, linear non-Gaussian acyclic model (LiNGAM), logistic regression, or principal component analysis (PCA) is used. The causality model may also be used in combination with a constraint-based approach such as a PC algorithm or a three phase dependency analysis (TPDA) algorithm.

The causality information correction unit 12 will be described in detail.

The causality information correction unit 12 corrects the causality information calculated by the causality information calculation unit 11, based on the function information indicating the functions respectively associated with the two selected components.

Specifically, the causality information correction unit 12 first refers to the component information using the identifiers of the two components in each of the pairs, and obtains two pieces of function information respectively associated with the two components.

For example, in the case of the component information 21 shown in FIG. 2, when the above-described pair is (X→Y), the label SV associated with the identifier X and the label MV associated with the identifier Y are obtained. The functions of the pairs (Y→X), (X→Z), (Z→X), (Y→Z), and (Z→Y) are obtained in a similar manner.

Next, the causality information correction unit 12 refers to the correction determination information stored in advance in the storage device using the functions included in the two obtained pieces of function information, and obtains correction information for correcting the causality information.

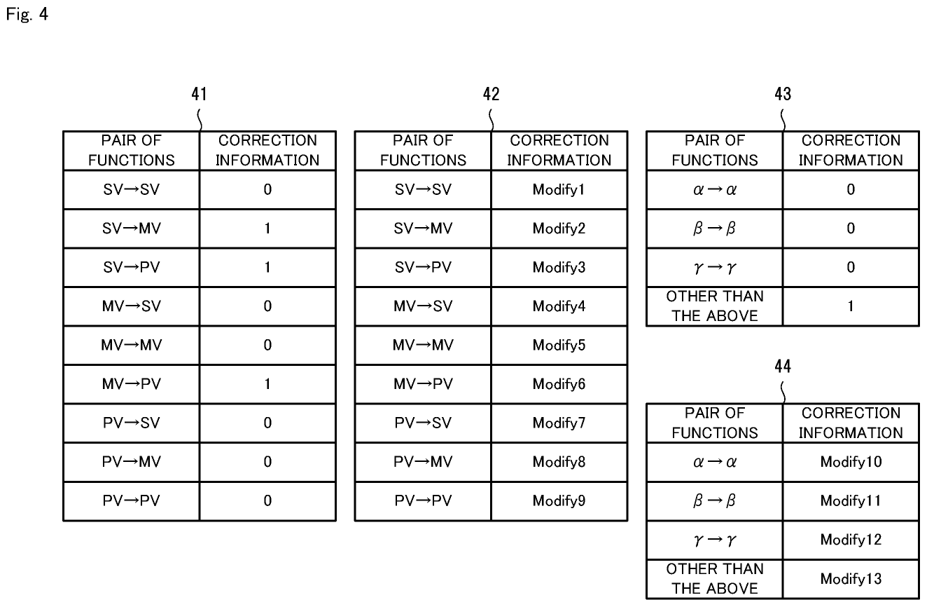

FIG. 4 is a diagram for explaining an example of correction determination information. The correction determination information is information in which a pair of functions respectively associated with the two components is associated with correction information for correcting the causality information.

As the correction information, for example, the following cases (A), (B), (C), and (D) are conceivable.

The correction information in case (A) is binary information indicating whether or not there is causality, which is determined based on a relationship between a pair of functions (pair of functions with a direction). In the binary information, for example, “1” is set when the pair has causality, and “0” is set when the pair does not have causality.

When the function information is the labels SV, MV, and PV as shown in the component information 21 in FIG. 2, in the correction information of the case (A), information (one binary value) indicating whether or not there is causality is associated with each of nine pairs of functions, as shown in the correction determination information 41 in FIG. 4.

The correction information in the case (B) is an index for correcting an index indicating a causality determined based on a relationship between a pair of functions (pair of functions with a direction). The index to be corrected is, for example, a score (correction score) with a direction between the functions.

In the correction information in the case (B), as shown in correction determination information 42 in FIG. 4, correction scores (Modify1 to Modify9) serving as the correction information are respectively associated with the nine pairs of functions.

The correction information in the case (C) is binary information that is determined based on the relationship between a pair of functions (pair of similar functions) and that indicates whether or not there is causality in the pair.

In the correction information in the case (C), as shown in correction determination information 43 in FIG. 4, it is assumed that there is no causality between components having a similar function, and the correction information is set to “0”. In contrast, it is assumed that there is causality between components having a dissimilar function to each other, and the correction information is set to “1”.

The correction information in the case (D) is an index (correction score) for correcting an index indicating a causality determined based on a relationship between a pair of functions (pair of similar functions).

In the correction information of the case (D), as shown in correction determination information 44 in FIG. 4, it is assumed that there is no causality between components having a similar function, and correction scores (Modify10 to Modify12) are set as the correction information. In contrast, it is assumed that there is causality between components having a dissimilar function to each other, and a correction score (Modify13) is set as the correction information.

The relationship between the pair of functions and the correction information will be described.

In the target system, when it is known that causality is unlikely to exist in a pair of functions such as MV→SV, MV→MV, and PV→PV, information for breaking the causality between components corresponding to the respective pairs of functions is set. That is to say, as shown in the correction determination information 41 in FIG. 4, “0” indicating that there is no causality is set.

In contrast, when it is known that causality is unlikely to occur in a pair of functions, information (correction score) for correcting the degree of the causality between components corresponding to the respective pairs of functions, that is to say, information (Modify1 to Modify9) for correcting the degree of causality is set as the correction information, as shown in the correction determination information 42 in FIG. 4. Specifically, a correction score to be subtracted from the causality score is set. For example, the value to be added to the causality score (the value of the correction score) is set to −0.5 or the like.

Also, in the target system, when it is known that causality is unlikely to exist in a pair of functions such as α→α, β→α, and γ→γ, information for breaking the causality between components corresponding to the respective pairs of functions is set. That is to say, as shown in the correction determination information 43 in FIG. 4, “0” indicating that there is no causality is set.

In contrast, in the target system, when it is known that causality is unlikely to exist in a pair of functions such as α→α, β→α, and γ→γ, information (correction score) for correcting the degree of causality between components corresponding to the respective pairs of functions, that is to say, information (Modify10 to Modify13) for correcting the degree of causality is set as the correction information, as shown in the correction determination information 44 in FIG. 4. Specifically, a correction score to be subtracted from the causality score is set. For example, in the components, the correction score to be subtracted from the causality score is set to −0.5 when the functions of the components are the same, and is set to 0 when the functions of the components are different from each other.

Obtainment of the correction information will be described.

For example, in the case of the above-described pair (X→Y), in the component information 21 in FIG. 2, the label associated with the identifier X is SV, and the label associated with the identifier Y is MV. Accordingly, in the case (A), the correction information “1” associated with (SV→MV) is obtained by referring to the correction determination information 41 shown in FIG. 4.

In the case (B), the correction information “Modify2” associated with (SV→MV) is obtained by referring to the correction determination information 42 shown in FIG. 4. The correction information is obtained using a similar method for the pairs (Y→X), (X→Z), (Z→X), (Y→Z), and (Z→Y).

In the case of the above-described pair (X→Y), in the component information 22 shown in FIG. 2, the label associated with the identifier X is α, and the label associated with the identifier Y is β. Accordingly, in the case (C), the correction information “1” corresponding to (α→β) is obtained by referring to the correction determination information 43 shown in FIG. 4.

In the case (D), the correction information “Modify13” corresponding to (α→β) is obtained by referring to the correction determination information 44 shown in FIG. 4.

Next, the causality information correction unit 12 corrects the causality information using the obtained correction information.

The causality information (causality information shown in 31 in FIG. 3) in the case (1) is corrected using the correction information (correction information 41 shown in FIG. 4) in the case (A). In this case, when the causality information is “0”, there is no causality between the two components of the target pair regardless of the correction information, and thus the causality information is set to “0”. In contrast, when the causality information is “1” and the correction information is “0”, it is determined that there is no causality between the two components of the target pair, and the causality information is corrected to “0”.

Alternatively, the causality information in the case (2) (causality information shown in 32 in FIG. 3) is corrected using the correction information in the case (A) (correction information shown in 41 in FIG. 4). When the correction information is “0”, the causality score is decreased, because there is no causality between the two components in the target pair regardless of the causality score indicated by the causality information. In contrast, when the correction information is “1”, the causality score indicated by the causality information is not corrected. Thereafter, when the causality score is a predetermined threshold or higher, it is determined that there is causality between the two components of the target pair.

Alternatively, the causality information in the case (2) (causality information shown in 32 in FIG. 3) is corrected using the correction information in the case (B) (correction information shown in 42 in FIG. 4). In this case, the causality score is corrected based on the causality score indicated by the causality information and the correction score indicated by the correction information. Thereafter, when the causality score is the predetermined threshold or higher, it is determined that there is causality between the two components in the target pair.

Alternatively, the causality information in the case (2) (causality information shown in 32 in FIG. 3) is corrected using the correction information in the case (C) (correction information shown in 43 in FIG. 4). In this case, when the correction information is “0”, the causality score is reduced because there is no causality between the two components of the target pair regardless of the causality score indicated by the causality information. In contrast, when the correction information is “1”, the causality score indicated by the causality information is not corrected. Thereafter, when the causality score is the predetermined threshold or higher, it is determined that there is causality between the two components of the target pair.

Alternatively, the causality information in the case (2) (causality information shown in 32 in FIG. 3) is corrected using the correction information in the case (D) (correction information shown in 44 in FIG. 4). In this case, the causality score is corrected based on the causality score indicated by the causality information and the correction score indicated by the correction information. Thereafter, when the causality score is the predetermined threshold or higher, it is determined that there is causality between the two components of the target pair.

### [System Configuration]

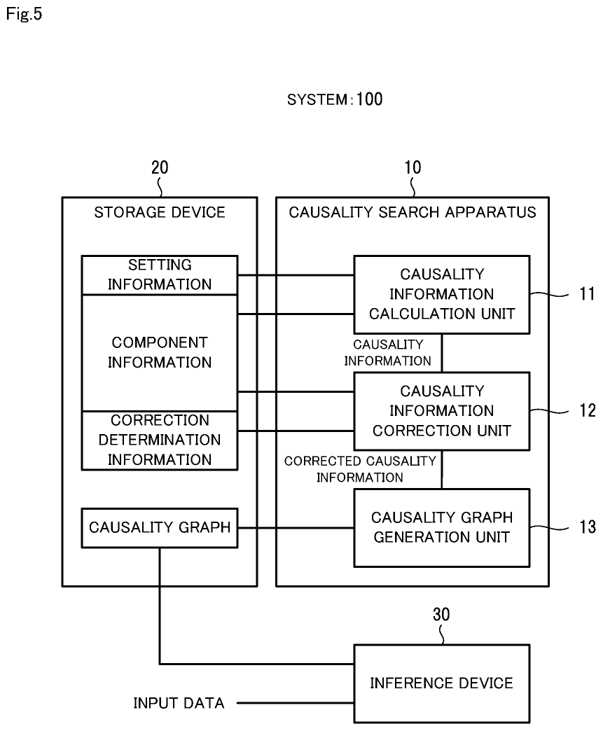

The configuration of the causality search apparatus 10 according to the first example embodiment will be described in more detail with reference to FIG. 5. FIG. 5 is a diagram for explaining an example of a system including a causality search apparatus.

A system 100 shown in FIG. 5 includes the causality search apparatus 10, a storage device 20, and an inference device 30. The causality search apparatus 10 includes the causality information calculation unit 11, the causality information correction unit 12, and a causality graph generation unit 13.

The storage device 20 stores information such as setting information, component information, correction determination information, and a causality graph. The storage device 20 is provided outside the causality search apparatus 10 in FIG. 5, but may also be provided inside the causality search apparatus 10. A plurality of storage devices 20 may also be provided, and the above-described pieces of information may be divided and stored in the storage devices 20. The storage device 20 is, for example, a storage device such as a database or a server device.

The setting information is information necessary for generating causality information. The component information and the correction determination information have been described above, and thus the description thereof will be omitted. A causality graph is a directed graph indicating the causality between components.

The inference device 30 is a device that executes an application for analyzing input data using a causality graph. For example, the inference device 30 is a device that designates an event to be analyzed in the input data, traces variables that affect the event based on the causality graph, and estimates the cause of the event.

The inference device 30 may also be a device that performs quantitative analysis (estimation of which variable has influenced the event to what extent, for example) by executing causality effect inference in advance and accumulating the inference result. Furthermore, the inference device 30 may also be a device that estimates the cause of the event and the time at which the event occurred with a certainty factor, using a Bayesian model or the like.

The inference device 30 may also be a device that receives abnormality data and analyzes the cause of the abnormality. In this case, in addition to estimating the variable and the time that are the cause of the specific abnormal event, the history of the degree of abnormality (abnormality score) before the abnormal event occurred can be explained using a Bayesian model or the like. This case is, for example, a case where the abnormality degree related to the component Y increases as a result of the abnormality being transmitted from the component X to the component Y at the time t, that is to say, as a result of the abnormality being transmitted through the side of the causality graph.

Furthermore, as the inference device 30 is conceivably a device that learns a prediction model according to causality effect inference and causality, and predicts and classifies an event that is not included in the data that has been learned. This method is realized by using, for example, linear regression, a support vector machine, a neural network, pruning according to a causality graph, or the like. As a result, by performing prediction and classification based on causality excluding false correlations, it is possible to avoid unreasonable prediction and classification in which a change in the state of a certain device affects the state of another device that has no causality with the certain device.

The causality search apparatus will be described.

The causality information calculation unit 11 and the causality information correction unit 12 have been described above, and thus the description thereof will be omitted.

The causality graph generation unit 13 generates a causality graph using a pair of components and the corrected causality information corresponding to the pair, and stores the generated causality graph in the storage device 20.

### [Apparatus Operation]

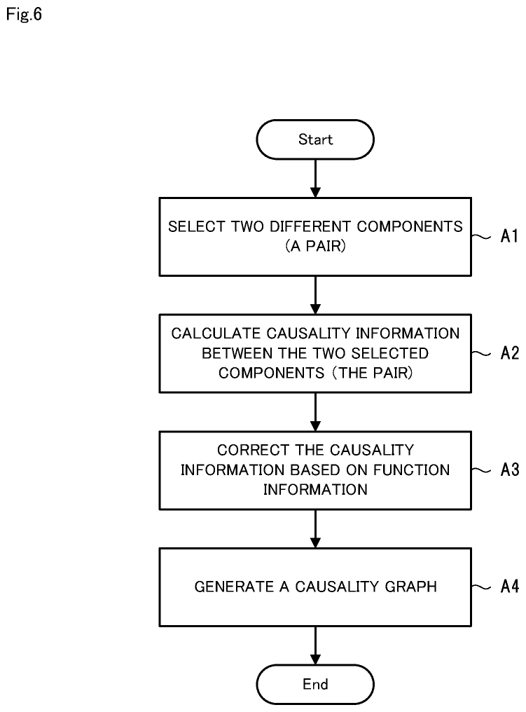

Next, operation of the causality search apparatus according to the first example embodiment will be described with reference to FIG. 6. FIG. 6 is a diagram for explaining an example of the operation of the causality search apparatus. In the following description, the drawings are referred to as appropriate. In the first example embodiment, a causality search method is implemented by causing the causality search apparatus to operate. Therefore, the description of the causality search method in the first example embodiment is replaced with the following description of the operation of the causality search apparatus.

First, the causality information calculation unit 11 selects two different components (a pair) from among a plurality of components provided in a target system (step A1). Specifically, in the step A1, the causality information calculation unit 11 selects two components in a permutation from among the plurality of components, based on the component information stored in the storage device (not illustrated).

Next, the causality information calculation unit 11 calculates causality information indicating the causality between the two selected components (the pair) (step A2). Specifically, in the step A2, for each pair, the causality information calculation unit 11 inputs the time-series data of the two components to a causality model for generating causality information indicating causality between the components, and calculates the causality information. As the causality information, for example, the above-described cases (1) and (2) are conceivable.

Next, the causality information correction unit 12 corrects the causality information based on function information indicating functions respectively associated with the two selected components (step A3).

Specifically, in the step A3, the causality information correction unit 12 first refers to the component information using the identifiers of the two components in each pair, and obtains pieces of function information respectively associated with the two components.

Next, in the step A3, the causality information correction unit 12 refers to the correction determination information stored in advance in the storage device using the functions included in the two obtained pieces of function information, and obtains correction information for correcting the causality information. As the correction information, for example, the above-described cases (A), (B), and (C) are conceivable.

Next, in the step A3, the causality information correction unit 12 corrects the causality information using the obtained correction information.

Next, the causality graph generation unit 13 generates a causality graph using a pair of components and the corrected causality information corresponding to the pair, and stores the generated causality graph in the storage device 20 (step A4).

### Effects of Example Embodiment

As described above, according to the example embodiment, the causality information indicating the causality between two components is corrected based on the functions associated with the respective components, and thus it is possible to accurately estimate the causality.

For example, because a system such as IoT/OT is a physical system and has a large amount of sensor data that moves substantially in synchronization with a delay, it is difficult to eliminate a false correlation. However, because a false correlation can be eliminated to some extent using the example embodiment, it is possible to accurately estimate the causality.

### [Program]

The program according to the example embodiment may be a program that causes a computer to execute steps A1 to A4 shown in FIG. 6. By installing this program in a computer and executing the program, the causality search apparatus and the causality search method according to the present example embodiment can be realized. Further, the processor of the computer performs processing to function as the causality information calculation unit 11, the causality information correction unit 12 and the causality graph generation unit 13.

Also, the program according to the example embodiment may be executed by a computer system constructed by a plurality of computers. In this case, for example, each computer may function as any of the causality information calculation unit 11, the causality information correction unit 12 and the causality graph generation unit 13.

### First Modified Example Embodiment

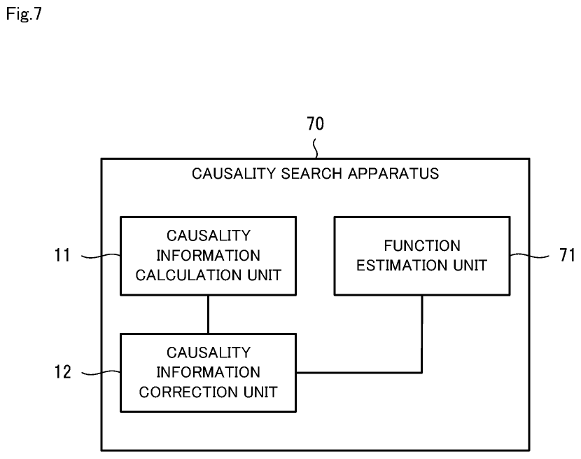

A configuration of a causality search apparatus according to a first modified example embodiment will be described with reference to FIG. 7. FIG. 7 is a diagram for explaining an example of the causality search apparatus according to the first modified example embodiment.

### [Apparatus Configuration]

A causality search apparatus 70 is an apparatus that accurately estimates causality between two components provided in a target system, based on the functions of the two components. In the first modified example embodiment, for example, even when function information (label) is not associated with a portion of the identifiers in the component information 21 or 22 shown in FIG. 2, the label can be estimated.

As shown in FIG. 7, the causality search apparatus 70 includes the causality information calculation unit 11, the causality information correction unit 12, and a function estimation unit 71. The causality information calculation unit 11 and the causality information correction unit 12 have been described above, and thus the description thereof will be omitted.

The function estimation unit 71 estimates the function information of the component with which no function information is associated, by inputting time-series data obtained from the component with which no function information is associated to the model for estimating the function information learned using the function information and the time-series data obtained from the component with which function information is associated.

Specifically, the function estimation unit 71 performs learning using labels (labels such as SV, MV, and PV indicating functions or labels such as α, β, and γ indicating only the similarity of functions) and time-series data obtained from components associated with the labels, and generates a label estimation model for estimating labels.

The label indicating the similarity of the functions is information that can determine only the similarity or dissimilarity of the functions of the components, by assigning the same label to the same or similar functions although the specific functions that the respective labels mean are unclear.

As the label estimation model, for example, a decision tree, linear regression, a support vector machine, a neural network, clustering such as k-means, a Bayesian model, or the like can be used. Distance learning or the like may also be used in combination.

The function estimation unit 71 estimates the label of the component with which no label is associated, by inputting time-series data obtained from the component with which the label is not associated to the label estimation model. Thereafter, the function estimation unit 71 associates the estimated label with the identifier of the component for which no label of component information is associated.

In the first modified example embodiment, the causality information correction unit 12 may also correct the causality information (causality score) using the determination amount used by the function estimation unit 71 at the time of label estimation.

For example, it is assumed that the function estimation unit 71 obtains SV:0.7, MV:0.2, and PV:0.1 as the determination amounts at the time of label estimation. In this case, the function estimation unit 71 estimates, as the label, the SV having the highest value among the determination amounts.

The causality score is then corrected using the determination amount of the two components. For example, a case where the fact that causality of MV→SV and SV→SV is unlikely to exist is reflected will be considered. In this case, when the determination amounts of one component are SV:0.7, MV 0.2, and PV:0.1 and the determination amounts of the other component are SV:0.4, MV:0.3, and PV:0.3, a correction score of −0.2×0.4−0.7×0.4=−0.36 may be added to the causality score to correct the causality score.

### Effects of First Modified Example Embodiment

As described above, according to the first modified example embodiment, even when function information (label) is not associated with a portion of the identifiers, a label can be estimated. As a result, the causality information indicating the causality between two components is corrected based on the functions associated with the respective components, and thus it is possible to accurately estimate the causality.

### Second Modified Example Embodiment

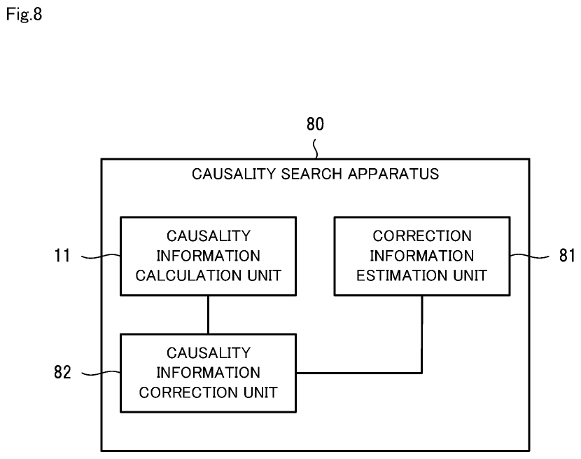

A configuration of a causality search apparatus according to a second modified example embodiment will be described with reference to FIG. 8. FIG. 8 is a diagram for explaining an example of a causality search apparatus according to the second modified example embodiment.

### [Apparatus Configuration]

A causality search apparatus 80 is an apparatus that accurately estimates causality between two components provided in a target system. In the second modified example embodiment, for example, even when the function information (labels) is not associated with all the identifiers in the component information 21 and 22 shown in FIG. 2, the correction information can be estimated. In the second modified example embodiment, no identifier has a label, and thus it is determined that the functions are similar when the similarity is high.

As shown in FIG. 8, the causality search apparatus 80 includes the causality information calculation unit 11, a correction information estimation unit 81, and a causality information correction unit 82. The causality information calculation unit 11 has been described above, and thus the description thereof will be omitted.

The correction information estimation unit 81 estimates similarity using time-series data obtained from two components with which no function information is associated, and estimates correction information based on the estimated similarity.

Specifically, the correction information estimation unit 81 first obtains time-series data from each of the two components. Next, the correction information estimation unit 81 estimates the similarity between the time-series data obtained from the two selected components using, for example, a Kullback-Leibler distance, a Jensen-Shannon distance, an f-divergence, a Hellinger distance, a Wasserstein distance, or the like. Next, the correction information estimation unit 81 estimates correction information based on the estimated similarity.

The causality information correction unit 82 first obtains the causality information (causality score) calculated by the causality information calculation unit 11 and the correction information (correction score) estimated by the correction information estimation unit 81. Next, the causality information correction unit 82 corrects the causality information (causality score) using the correction information (correction score).

For example, when the similarity between time-series data of the two components X and Y is 0.3, −0.3 is added to the causality score of X→Y and the causality score of Y→X, and thus it is determined that causality is unlikely to exist between variables that have a similar function.

### Effects of Second Modified Example Embodiment

As described above, according to the second modified example embodiment, even when function information (labels) is not associated with all identifiers, labels can be estimated as having similar functions when the similarity is high. As a result, the causality information indicating the causality between two components is corrected based on the functions associated with the respective components, and thus it is possible to accurately estimate the causality.

### [Physical Configuration]

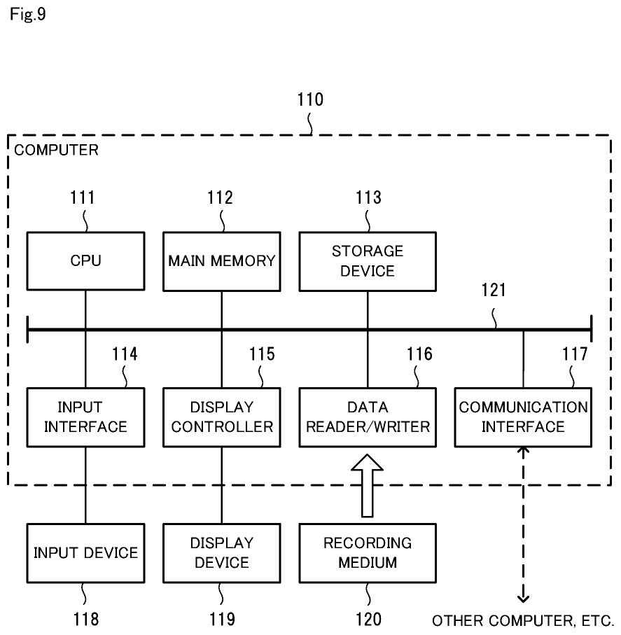

Here, a computer that realizes the causality search apparatus by executing the program according to the example embodiment, the first modified example embodiment and the second modified example embodiment will be described with reference to FIG. 9. FIG. 9 is a diagram for explaining an example of a computer that realizes a causality search apparatus according to the example embodiment, the first modified example embodiment and the second modified example embodiment.

As shown in FIG. 9, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the causality search apparatus according to the example embodiment, the first modified example embodiment and the second modified example embodiment can also be realized by using hardware corresponding to each unit. Furthermore, a portion of the causality search apparatus may be realized by a program, and the remaining portion realized by hardware.

### [Supplementary Note]

Furthermore, the following supplementary notes are disclosed regarding the example embodiments described above. Some portion or all of the example embodiments described above can be realized according to (supplementary note 1) to (supplementary note 15) described below, but the below description does not limit the present invention.

### (Supplementary Note 1)

A causality search apparatus comprising:

a causality information calculation unit that selects two different components from a plurality of components provided in a target system and calculates causality information indicating causality between the two selected components; and

a causality information correction unit that corrects the causality information based on function information indicating functions respectively associated with the two selected components.

### (Supplementary Note 2)

The causality search apparatus according to supplementary note 1,

wherein the causality information correction unit determines that there is no causality between the two selected components when the function information of each of the two selected components indicates the same function.

### (Supplementary Note 3)

The causality search apparatus according to supplementary note 1,

wherein the causality information correction unit determines correction information used to restrict a false correlation based on the function information, and corrects the causality information based on the correction information.

### (Supplementary Note 4)

The causality search apparatus according to any one of supplementary notes 1 to 3, further comprising

a function estimation unit that estimates a function of a component with which the function information is not associated, by inputting time-series data obtained from the component with which the function information is not associated to a model for estimating the function information learned using the function information and time-series data obtained from the component with which the function information is associated.

(Supplementary note 5)

The causality search apparatus according to supplementary note 3, further comprising

a correction information estimation unit that estimates a similarity using the time-series data obtained from the two components with which the function information is not associated, and for estimating the correction information based on the estimated similarity.

### (Supplementary Note 6)

A causality search method comprising:

a causality information calculation step of selecting two different components from a plurality of components provided in a target system and calculating causality information indicating causality between the two selected components; and

a causality information correction step of correcting the causality information based on function information indicating functions respectively associated with the two selected components.

### (Supplementary Note 7)

The causality search method according to supplementary note 6, further comprising

in the causality information correction step, determining that there is no causality between the two selected components when the function information of each of the two selected components indicates the same function.

### (Supplementary Note 8)

The causality search method according to supplementary note 6, further comprising

in the causality information correction step, determining correction information used to restrict a false correlation based on the function information, and correcting the causality information based on the correction information.

### (Supplementary Note 9)

The causality search method according to any one of supplementary notes 6 to 8, further comprising

a function estimation step of estimating a function of a component with which the function information is not associated, by inputting time-series data obtained from the component with which the function information is not associated to a model learned using time-series data obtained from the component with which the function information is associated.

### (Supplementary Note 10)

The causality search method according to supplementary note 8, further comprising

a correction information estimation step of estimating a similarity using the time-series data obtained from the two components with which the function information is not associated, and estimating the correction information based on the estimated similarity.

### (Supplementary Note 11)

A computer readable recording medium that includes a program recorded thereon, the program including instructions that causes a computer to carry out:

a causality information calculation step of selecting two different components from a plurality of components provided in a target system and calculating causality information indicating causality between the two selected components; and

a causality information correction step of correcting the causality information based on function information indicating functions respectively associated with the two selected components.

### (Supplementary Note 12)

The computer readable recording medium according to supplementary note 11,

wherein in the causality information correction step, determining that there is no causality between the two selected components when the function information of each of the two selected components indicates the same function.

### (Supplementary Note 13)

The computer readable recording medium according to supplementary note 11,

wherein in the causality information correction step, determining correction information used to restrict false correlation based on the function information; and correcting the causality information based on the correction information.

### (Supplementary Note 14)

The computer readable recording medium according to any one of supplementary notes 11 to 13,

wherein the program includes an instruction that causes the computer to carry out

a function estimation step of estimating a function of a component with which the function information is not associated, by inputting time-series data obtained from the component with which the function information is not associated to a model learned using time-series data obtained from the component with which the function information is associated.

### (Supplementary Note 15)

The computer readable recording medium according to supplementary note 13,

wherein the program includes an instruction that causes the computer to carry out:

a correction information estimation step of estimating a similarity using the time-series data obtained from the two components with which the function information is not associated; and

estimating the correction information based on the estimated similarity.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention.

### INDUSTRIAL APPLICABILITY

As described above, according to the present invention, the causality can be accurately estimated. The present invention is useful in field of using causality.

### LIST OF REFERENCE SIGNS

10, 70, 80 Causality search apparatus
11 Causality information calculation unit
12 Causality information correction unit
13 Causality graph generation unit
20 Storage device
30 Inference device
71 Function estimation unit
81 Correction information estimation unit
82 Causality information correction unit
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A causality search apparatus comprising:
at least one memory storing instructions; and
at least one processor configured to execute the instructions to:
select two different components from a plurality of components provided in a target system and calculate causality information indicating causality between the two selected components; and
correct the causality information based on function information indicating functions respectively associated with the two selected components.

2. The causality search apparatus according to claim 1,
wherein at least one processor is further configured to execute the instructions to:
determines that there is no causality between the two selected components when the function information of each of the two selected components indicates the same function.

3. The causality search apparatus according to claim 1,
wherein at least one processor is further configured to execute the instructions to:
determines correction information used to restrict a false correlation based on the function information, and corrects the causality information based on the correction information.

4. The causality search apparatus according to claim 1, wherein at least one processor is further configured to execute the instructions to:
estimates a function of a component with which the function information is not associated, by inputting time-series data obtained from the component with which the function information is not associated to a model for estimating the function information learned using the function information and time-series data obtained from the component with which the function information is associated.

5. The causality search apparatus according to claim 3, wherein at least one processor is further configured to execute the instructions to:
estimates a similarity using the time-series data obtained from the two components with which the function information is not associated, and for estimating the correction information based on the estimated similarity.

6. A causality search method comprising:
selecting two different components from a plurality of components provided in a target system and calculating causality information indicating causality between the two selected components; and
correcting the causality information based on function information indicating functions respectively associated with the two selected components.

7. The causality search method according to claim 6, further comprising
determining that there is no causality between the two selected components when the function information of each of the two selected components indicates the same function.

8. The causality search method according to claim 6, further comprising
determining correction information used to restrict a false correlation based on the function information, and correcting the causality information based on the correction information.

9. The causality search method according to claim 6, further comprising
estimating a function of a component with which the function information is not associated, by inputting time-series data obtained from the component with which the function information is not associated to a model learned using time-series data obtained from the component with which the function information is associated.

10. The causality search method according to claim 8, further comprising
estimating a similarity using the time-series data obtained from the two components with which the function information is not associated, and estimating the correction information based on the estimated similarity.

11. A non-transitory computer readable recording medium that includes a program recorded thereon, the program including instructions that causes a computer to carry out the steps of:
selecting two different components from a plurality of components provided in a target system and calculating causality information indicating causality between the two selected components; and
correcting the causality information based on function information indicating functions respectively associated with the two selected components.

12. The non-transitory computer readable recording medium according to claim 11,
wherein it is determined that there is no causality between the two selected components when the function information of each of the two selected components indicates the same function.

13. The non-transitory computer readable recording medium according to claim 11,
wherein the program further causes the computer to carry out:
determining correction information used to restrict false correlation based on the function information; and
correcting the causality information based on the correction information.

14. The non-transitory computer readable recording medium according to claim 11,
wherein the program includes an instruction that causes the computer to carry out
estimating a function of a component with which the function information is not associated, by inputting time-series data obtained from the component with which the function information is not associated to a model learned using time-series data obtained from the component with which the function information is associated.

15. The non-transitory computer readable recording medium according to claim 13,
wherein the program includes an instruction that causes the computer to carry out:
estimating a similarity using the time-series data obtained from the two components with which the function information is not associated; and
estimating the correction information based on the estimated similarity.
